(19) United States
(12) Patent Application Publication
(10) Pub. No.: US 2014/0333606 A1
(43) Pub. Date: Nov. 13, 2014

(54) Driving Unit, Driving Method and Related LCD

(71) Applicant: Dongguang Wu, Shenzhen City (CN)

(72) Inventor: Dongguang Wu, Shenzhen City (CN)

(73) Assignee: Shenzhen China Star Optoelectronics Technology Co., Ltd., Shenzhen City, Guangdong (CN)

(21) Appl. No.: 13/982,496

(22) PCT Filed: Jun. 26, 2013
(86) PCT No.: PCT/CN2013/078032

§ 371 Date: Jul. 30, 2013

(30) Foreign Application Priority Data
May 7, 2013 (CN) 201310163492.1

(51) Int. Cl. G09G 3/36

(52) U.S. Cl. CPC G09G 3/36
USPC 345/213

(57) ABSTRACT

A driver for use in a liquid crystal display (LCD) includes a signal generator for supplying direct current (DC) voltage and control signal, the control signal comprising 3D enabling signal, a timing controlling module coupled to the signal generator, for receiving the 3D enabling signal, and a DC/DC converter coupled to the signal generator, for outputting vertical synchronous signal to a gate driver to drive a pixel array of the LCD upon receiving 3D enabling signal. The present invention also proposes a driving method for driving an LCD and related LCD. The present invention proposes a simplified circuit design and reduce cost.

### BACKGROUND OF THE INVENTION

1. Field of the Invention

The present invention relates to a Thin Film Transistor Liquid Crystal Display (TFT-LCD) field, more particularly, to a driving unit for use in an LCD, a driving method and a related LCD.

2. Description of the Related Art

A TFT-LCD is widely used. As shown in FIG. 1 illustrating a schematic diagram of a conventional LCD, the LCD includes a pixel array 10, a source driver 11, a gate driver 12, a timing controller 14, a DC/DC converter 16, a signal generator 15 and a backlight module 13. The signal generator 15 at system end generates 3D enabling signal (3D_EN signal) to the timing controller 14. And then the timing controller 14 transmits the 3D enabling signal to the DC/DC converter 16. Furthermore, the timing controller 14 further supplies vertical synchronous signal (VSYNC signal) to the DC/DC converter 16. Therefore, a use of a cable and a connector disposed between the timing controller 14 and the DC/DC converter 16 is necessary. Such design is more complex and raises cost.

### SUMMARY OF THE INVENTION

An objective of the present invention is to provide a driving unit used in an LCD, a driving method and a related LCD, to save the cost.

In one aspect of the present invention, a driver for use in a liquid crystal display (LCD) comprises a signal generator for supplying direct current (DC) voltage and control signal, the control signal comprising 3D enabling signal, a timing controlling module coupled to the signal generator, for receiving the 3D enabling signal, and a DC/DC converter coupled to the signal generator, for outputting vertical synchronous signal to a gate driver to drive a pixel array of the LCD upon receiving 3D enabling signal.

Preferably, the DC/DC converter comprises a 3D enabling signal detecting unit, for receiving and detecting the 3D enabling signal from the signal generator, a vertical synchronous signal (VSYNC) generating unit for outputting vertical synchronous signal upon the condition that the 3D enabling signal detecting unit detects high voltage level of the 3D enabling signal, and a vertical synchronous signal (VSYNC) transmitting unit for transmitting the vertical synchronous signal to the gate driver.

Preferably, the driver further comprises a gate driver coupled to the DC/DC converter, for driving the pixel array in response to the vertical synchronous signal generated by the DC/DC converter, and a source driver coupled to the timing controller, for driving the pixel array in response to the horizontal synchronous signal generated by the timing controller.

In another aspect of the present invention, an LCD comprises a backlight module, a pixel array, a signal generator for supplying direct current (DC) voltage and control signal comprising 3D enabling signal, a timing controlling module coupled to the signal generator for receiving the 3D enabling signal, a DC/DC converter coupled to the signal generator, for outputting vertical synchronous signal upon receiving 3D enabling signal, a gate driver coupled to the DC/DC converter for driving the pixel array in response to the vertical synchronous signal generated by the DC/DC converter and a source driver coupled to the timing controller for driving the pixel array in response to the horizontal synchronous signal generated by the timing controller.

Preferably, the DC/DC converter comprises a 3D enabling signal detecting unit for receiving and detecting the 3D enabling signal from the signal generator, a vertical synchronous signal (VSYNC) generating unit for outputting vertical synchronous signal upon the condition that the 3D enabling signal detecting unit detects high voltage level of the 3D enabling signal, and a vertical synchronous signal (VSYNC) transmitting unit, for transmitting the vertical synchronous signal to the gate driver.

Preferably, the signal generator is a SoC chip at a system end.

In still another aspect of the present invention, a driving method for driving an LCD comprises: providing a signal generator for supplying DC voltage and control signal comprising 3D enabling signal; providing a timing controller coupled to the signal generator for receiving the 3D enabling signal; providing a DC/DC converter coupled to the signal generator for generating vertical synchronous signal upon receiving the 3D enabling signal, the vertical synchronous signal being fed to a gate driver to drive a pixel array.

Preferably, the driving method further comprises: receiving and detecting the 3D enabling signal from the signal generator by using the DC/DC converter; outputting vertical synchronous signal in response to high voltage level of the 3D enabling signal; transmitting the vertical synchronous signal to the gate driver.

Preferably, the driving method further comprises driving the pixel array by using the vertical synchronous signal from the DC/DC converter and the horizontal synchronous signal from the timing controller.

In contrast to prior art, the embodiment of the present invention presents advantages as follows:

Since the vertical synchronous signal is generated by the DC/DC converter, and the 3D enabling signal is generated by the signal generator at the system end, using a connector and a cable to transmit vertical synchronous signal and 3D enabling signal between the timing controller and the DC/DC converter is no longer required, thereby simplifying the circuit design and reducing cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a conventional LCD.

FIG. 2 illustrates a schematic diagram of a driving unit for use in an LCD according to a preferred embodiment of the present invention.

FIG. 3 illustrate a block diagram of the DC/DC converter as shown in FIG. 2

### DESCRIPTION OF THE EMBODIMENTS

The present invention is described in detail in conjunction with the accompanying drawings and embodiments.

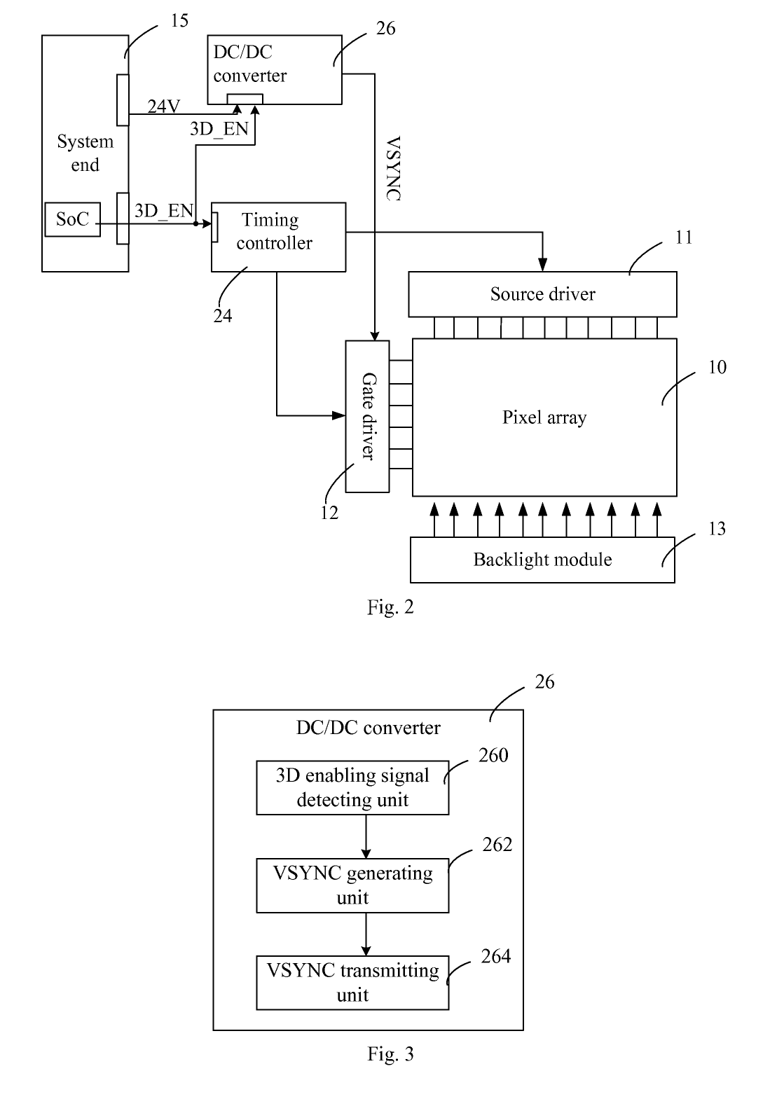

Referring to FIG. 2 illustrating a schematic diagram of a driving unit for use in an LCD according to a preferred embodiment of the present invention, the LCD comprises a pixel array 10, a source driver 11, a gate driver 12, a timing controller 24, a DC/DC converter 26, a signal generator 15 and a backlight module 13.

The backlight module 13 is used for supplying backlight, so that a user can see the display of the pixel array 10 by using the backlight.

The signal generator 15 is used for supplying voltage (e.g. DC supply voltage of 24V) and control signal including 3D enabling signal. Specifically, the signal generator 15 can be a SoC (System on a chip) chip in a system end.

The timing controller 24 coupled to the signal generator 15 is used for receiving the 3D enabling signal and controlling time periods associated with the source driver 11 transmitting data and the gate driver 12 switching the pixel units.

The DC/DC converter 26 coupled to the signal generator 15 is used for generating vertical synchronous signal upon receiving the 3D enabling signal. The vertical synchronous signal is fed to the gate driver 14 to drive the pixel array 10 of the LCD.

The source driver 11 and the gate driver 12 couples to pixel units (not shown) of the pixel array 10. When the gate driver 14 transmits scan signal to turn on pixel units in a row, the source driver 12 transmits data to the pixel units to display image. Specifically, the gate driver 12 coupled to the DC/DC converter 26 is used for driving the pixel array 10 in response to the vertical synchronous signal generated by the DC/DC converter 26. The source driver 11 coupled to the timing controller 24 is used for driving the pixel array 10 in response to the horizontal synchronous signal (HSYNC signal) generated by the timing controller 24.

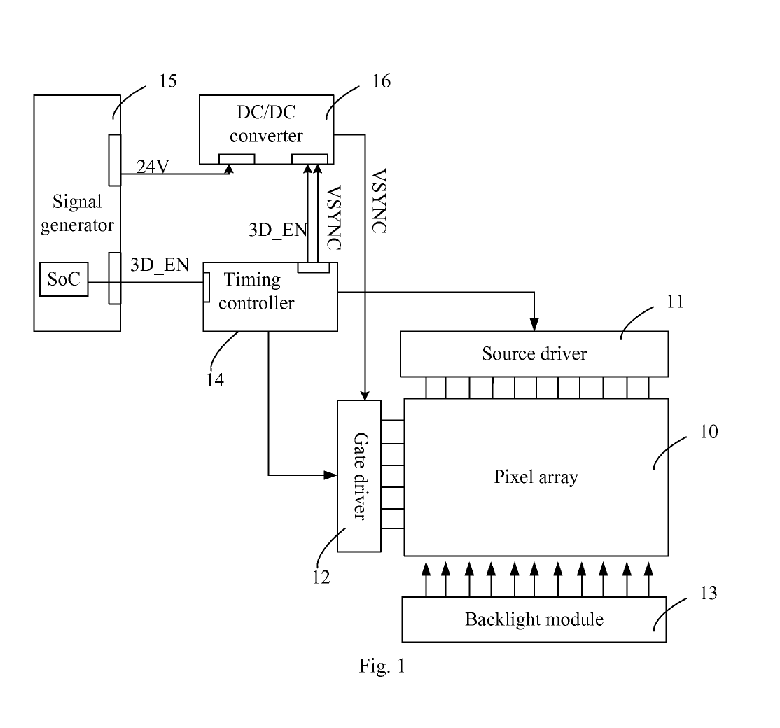

Referring to FIG. 3 illustrating a schematic diagram of the DC/DC converter 26 as shown in FIG. 1, the DC/DC converter 26 comprises a 3D enabling signal detecting unit 260 for receiving and detecting the 3D enabling signal from the signal generator 15, a vertical synchronous signal (VSYNC) generating unit 262 for outputting vertical synchronous signal upon the condition that the 3D enabling signal detecting unit 260 detects high voltage level of the 3D enabling signal, and a vertical synchronous signal (VSYNC) transmitting unit 264 for transmitting the vertical synchronous signal to the gate driver 12.

Practically, the above-mentioned units can be implemented in a microcontroller (MCU) of the DC/DC converter 26.

In another aspect, the present invention provides a driving method for driving an LCD. The driving method comprises the following steps:

Step 1: providing a signal generator for supplying DC voltage and control signal including 3D enabling signal;

Step 2: providing a timing controller coupled to the signal generator for receiving the 3D enabling signal;

Step 3: providing a DC/DC converter coupled to the signal generator for generating vertical synchronous signal upon receiving the 3D enabling signal. The vertical synchronous signal is fed to a gate driver to drive a pixel array.

Furthermore, the driving method further comprises steps of:

receiving and detecting the 3D enabling signal from the signal generator by using the DC/DC converter;

outputting vertical synchronous signal in response to high voltage level of the 3D enabling signal; and

transmitting the vertical synchronous signal to the gate driver.

The gate driver and the source driver drive the pixel array by using the vertical synchronous signal from the DC/DC converter and the horizontal synchronous signal from the timing controller.

According to the present invention, since the vertical synchronous signal is generated by the DC/DC converter and the 3D enabling signal is generated by the signal generator at the system end, using a connector and a cable to transmit vertical synchronous signal and 3D enabling signal between the timing controller and the DC/DC converter is no longer required, thereby simplifying the circuit design and reducing cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driver for use in a liquid crystal display (LCD) comprising:
a signal generator for supplying direct current (DC) voltage and control signal, the control signal comprising 3D enabling signal;
a timing controlling module coupled to the signal generator, for receiving the 3D enabling signal; and
a DC/DC converter coupled to the signal generator, for outputting vertical synchronous signal to a gate driver to drive a pixel array of the LCD upon receiving 3D enabling signal.

2. The driver for use in the LCD as claimed in claim 1 wherein the DC/DC converter comprises:
a 3D enabling signal detecting unit for receiving and detecting the 3D enabling signal from the signal generator;
a vertical synchronous signal (VSYNC) generating unit for outputting vertical synchronous signal upon the condition that the 3D enabling signal detecting unit detects high voltage level of the 3D enabling signal; and
a vertical synchronous signal (VSYNC) transmitting unit for transmitting the vertical synchronous signal to the gate driver.

3. The driver for use in the LCD as claimed in claim 1 further comprising:
a gate driver coupled to the DC/DC converter, for driving the pixel array in response to the vertical synchronous signal generated by the DC/DC converter; and
a source driver coupled to the timing controller, for driving the pixel array in response to the horizontal synchronous signal generated by the timing controller.

4. The driver for use in the LCD as claimed in claim 3 wherein the signal generator is a SoC chip at a system end.

5. The driver for use in the LCD as claimed in claim 2 further comprising:
a gate driver coupled to the DC/DC converter, for driving the pixel array in response to the vertical synchronous signal generated by the DC/DC converter; and
a source driver coupled to the timing controller, for driving the pixel array in response to the horizontal synchronous signal generated by the timing controller.

6. An LCD comprising:
a backlight module;
a pixel array;
a signal generator for supplying direct current (DC) voltage and control signal, the control signal comprising 3D enabling signal;
a timing controlling module coupled to the signal generator, for receiving the 3D enabling signal;
a DC/DC converter coupled to the signal generator, for outputting vertical synchronous signal upon receiving 3D enabling signal;
a gate driver coupled to the DC/DC converter, for driving the pixel array in response to the vertical synchronous signal generated by the DC/DC converter; and
a source driver coupled to the timing controller, for driving the pixel array in response to the horizontal synchronous signal generated by the timing controller.

7. The LCD as claimed in claim 6 wherein the DC/DC converter comprises:
a 3D enabling signal detecting unit for receiving and detecting the 3D enabling signal from the signal generator;
a vertical synchronous signal (VSYNC) generating unit for outputting vertical synchronous signal upon the condition that the 3D enabling signal detecting unit detects high voltage level of the 3D enabling signal; and
a vertical synchronous signal (VSYNC) transmitting unit for transmitting the vertical synchronous signal to the gate driver.

8. The LCD as claimed in claim 6 wherein the signal generator is a SoC chip at a system end.

9. The LCD as claimed in claim 7 wherein the signal generator is a SoC chip at a system end.

10. A driving method for driving an LCD, comprising:
providing a signal generator for supplying DC voltage and control signal comprising 3D enabling signal;
providing a timing controller coupled to the signal generator for receiving the 3D enabling signal; and
providing a DC/DC converter coupled to the signal generator for generating vertical synchronous signal upon receiving the 3D enabling signal, the vertical synchronous signal being fed to a gate driver to drive a pixel array.

11. The driving method as claimed in claim 10 further comprising:
receiving and detecting the 3D enabling signal from the signal generator by using the DC/DC converter;
outputting vertical synchronous signal in response to high voltage level of the 3D enabling signal; and
transmitting the vertical synchronous signal to the gate driver.

12. The driving method as claimed in claim 11 further comprising:
driving the pixel array by using the vertical synchronous signal from the DC/DC converter and the horizontal synchronous signal from the timing controller.
